(19) United States
(12) Patent Application Publication
(10) Pub. No.: US 2024/0339720 A1
(43) Pub. Date: Oct. 10, 2024

(54) BATTERY PACK AND VEHICLE

(71) Applicant: YAMAHA HATSUDOKI KABUSHIKI KAISHA, Iwata-shi (JP)

(72) Inventor: Tokinari NAGAO, Shizuoka (JP)

(21) Appl. No.: 18/622,630

(22) Filed: Mar. 29, 2024

(30) Foreign Application Priority Data
Apr. 5, 2023 (JP) 2023-061298

(51) Int. Cl. H01M 50/367; H01M 50/249

(52) U.S. Cl. CPC H01M 50/367; H01M 50/249; H01M 2220/20

(57) ABSTRACT

A battery pack, including a battery module, a casing that houses the battery module, and a first wall portion. The casing has: a wall of which an inner surface is a first surface, the battery module being arranged with an interval from the first surface so as to form a first gas passageway between the battery module and the first surface; and an outlet formed in the wall, gas inside the casing being dischargeable, sequentially through the first gas passageway and the outlet, to an outside of the casing. The first wall portion extends from the first surface of the casing, and is shaped so as to extend away from the first surface while extending toward an upstream side of the first gas passageway.

### CROSS-REFERENCE TO RELATED APPLICATIONS

This application claims priority from a Japanese Patent Application No. 2023-061298, filed on Apr. 5, 2023, the content of which is incorporated herein by reference.

### BACKGROUND

### 1. Technical Field

The present invention relates to a battery pack and a vehicle.

### 2. Description of the Related Art

There are electric vehicles that run on an electric motor as a drive source. The electric motor rotates by receiving electric power from a battery pack mounted on the vehicle, and the rotation of the electric motor is transmitted to the wheels to enable the vehicle to run.

A plurality of battery cells are arranged inside a battery pack. When the pressure inside the battery cells increases, gas may be discharged from the battery cells. The casing of the battery pack is provided with an outlet through which to discharge the gas inside the casing to the outside. The gas discharged from the battery cells is discharged to the outside of the battery pack through the outlet. As the gas generated from the battery cells flows toward the outlet, particulate matter derived from the constituents of the battery cells may move together with the gas toward the outlet.

International Publication WO2019/176415 pamphlet discloses a battery pack having an exhaust duct provided inside the casing for discharging the gas generated from battery cells to the outside. The exhaust duct has a rectangular cross section, and a plurality of exhaust guide members extend from each of two opposing inner surfaces of the exhaust duct. The particulate matter described above can be captured by those exhaust guide members.

### SUMMARY

When solid objects occur that move in the casing of a battery pack, it is required to efficiently capture the objects.

The present specification discloses a battery pack and a vehicle as set forth in the following items.

### [Item 1]

A battery pack including:
a battery module; and
a casing that houses the battery module, wherein:
the battery module is arranged with an interval from a first surface of the casing opposing the battery module so as to form a first gas passageway between the battery module and the first surface of the casing;
an outlet through which to discharge gas inside the casing to outside is located on the first surface of the casing; and
the battery pack further includes a first wall portion extending from the first surface of the casing where the outlet is located, the first wall portion being shaped so as to extend in a direction away from the first surface while extending toward an upstream side of the first gas passageway.

The battery pack according to an embodiment of the present invention includes the first wall portion that extends from the first surface of the casing where the outlet is located. The first wall portion is shaped so as to extend in a direction away from the first surface of the casing while extending toward the upstream side of the first gas passageway. When solid objects derived from the constituents of the battery cells occur, it is possible to capture those solid objects by the first wall portion.

Many components are required to be arranged inside the casing of the battery pack. Therefore, the interval can be small between the first surface of the casing opposing the battery module and the battery module. The length of the first surface of the casing in the width direction is larger relative to the interval. With the length of the first surface of the casing in the width direction being large, the length of the root portion of the wall portion fixed to the first surface can be made large, thereby increasing the rigidity of the wall portion. For example, if the wall portion has a cantilevered structure, the length of the fixed end that is fixed to the first surface of the casing can be made large, thereby increasing the rigidity of the wall surface. Therefore, even under conditions where high stress is applied to the wall portion due to the movement of the gas and the solid objects, it is possible to suppress distortion of the wall portion and efficiently capture the solid objects.

With the provision of the wall portion for capturing the solid objects in the casing of the battery pack, it is possible to efficiently capture the solid objects with a simple structure. Since there is no need to provide relatively large components such as an exhaust duct in the casing, it is possible to increase the degree of freedom in the arrangement of components in the casing and reduce the size of the battery pack.

### [Item 2]

The battery pack according to item 1, wherein:
in plan view as seen from a width direction of the first surface of the casing,
the first wall portion is shaped so as to extend in a direction diagonal to an axial direction of the outlet and away from the first surface.

Thus, solid objects that move through the first gas passageway can be captured by the first wall portion.

### [Item 3]

The battery pack according to item 1 or 2, wherein the first wall portion includes:
a first portion shaped such that one end thereof extends from the first surface of the casing and so as to extend away from the first surface while extending toward the upstream side of the first gas passageway; and
a second portion that extends from the other end of the first portion in a direction toward the upstream side of the first gas passageway, with inclination of the second portion relative to the first surface being smaller than inclination of the first portion relative to the first surface.

Thus, it is possible to increase the space to capture the solid objects.

### [Item 4]

The battery pack according to any one of items 1 to 3, further including:

a baffle plate arranged between the battery module and the first surface of the casing, wherein:
the first gas passageway is formed between the baffle plate and the first surface of the casing; and
the first wall portion is arranged so as to provide a gap between the first wall portion and the baffle plate.

Thus, it is possible to prevent the solid objects discharged from the battery module from heading directly to the outlet without passing through the location where the first wall portion is arranged to capture those solid objects. It is possible to guide those solid objects to a location where the first wall portion is arranged.

### [Item 5]

The battery pack according to item 4, further including a second wall portion that extends from a second surface of the baffle plate opposing the first surface of the casing, wherein the second wall portion is shaped so as to extend away from the second surface while extending toward the upstream side of the first gas passageway and is provided so as to provide a gap between the second wall portion and the first surface of the casing.

As the solid objects are captured by means of both the first wall portion and the second wall portion, which extend in different directions, it is possible to more efficiently capture the solid objects.

### [Item 6]

The battery pack according to item 5, wherein the first wall portion and the second wall portion are arranged staggered from each other in a longitudinal direction of the first surface of the casing.

Thus, it is possible to efficiently capture the solid objects, which have a relatively large mass and are difficult to change their direction of travel. [Item 7]

The battery pack according to any one of items 4 to 6, wherein:
a control device that controls an operation of the battery pack,
wherein the control device is provided on the baffle plate.

Thus, the control device can be supported by the baffle plate. [Item 8]

The battery pack according to any one of items 1 to 3, wherein:
a second gas passageway, separate from the first gas passageway, is further formed between the first surface of the casing and the battery module, wherein the second gas passageway has a different direction of gas flow than the first gas passageway; and
the battery pack further includes a third wall portion that extends from the first surface of the casing where the outlet is located, the third wall portion being shaped so as to extend in a direction away from the first surface while extending toward the upstream side of the second gas passageway.

By providing a plurality of gas passageways to guide the gas inside the casing to the outlet, it is possible to efficiently guide the gas in the casing to the outlet.

By arranging wall portions in the first gas passageway and the second gas passageway, respectively, it is possible to efficiently capture the solid objects.

### [Item 9]

The battery pack according to any one of items 1 to 8, further including a pressure relief device provided on the casing so as to cover the outlet.

As the wall portions capture the solid objects, it is possible to reduce the amount of the solid objects that deposit in the pressure relief device.

### [Item 10]

A vehicle including the battery pack according to any one of items 1 to 9.

Thus, when solid objects derived from the constituents of the battery cells occur in the battery pack mounted on the vehicle, it is possible to capture those solid objects in the casing.

The battery pack according to an embodiment of the present invention includes the first wall portion that extends from the first surface of the casing where the outlet is located. The first wall portion is shaped so as to extend in a direction away from the first surface of the casing while extending toward the upstream side of the first gas passageway. When solid objects derived from the constituents of the battery cells occur, it is possible to capture those solid objects by the first wall portion.

Many components are required to be arranged inside the casing of the battery pack. Therefore, the interval can be small between the first surface of the casing opposing the battery module and the battery module. The length of the first surface of the casing in the width direction is larger relative to the interval. With the length of the first surface of the casing in the width direction being large, the length of the root portion of the wall portion fixed to the first surface can be made large, thereby increasing the rigidity of the wall portion. For example, if the wall portion has a cantilevered structure, the length of the fixed end that is fixed to the first surface of the casing can be made large, thereby increasing the rigidity of the wall surface. Therefore, even under conditions where high stress is applied to the wall portion due to the movement of the gas and the solid objects, it is possible to suppress distortion of the wall portion and efficiently capture the solid objects.

With the provision of the wall portion for capturing the solid objects in the casing of the battery pack, it is possible to efficiently capture the solid objects with a simple structure. Since there is no need to provide relatively large components such as an exhaust duct in the casing, it is possible to increase the degree of freedom in the arrangement of components in the casing and reduce the size of the battery pack.

### BRIEF DESCRIPTION OF THE DRAWINGS

FIG. 1 is a left side view showing an electric vehicle 1 according to an embodiment.

FIG. 2 is a left side view showing a battery pack 3 according to an embodiment.

FIG. 3 is a left side view showing, on an enlarged scale, a part of the battery pack 3 according to an embodiment.

FIG. 4 is a left side view showing, on an enlarged scale, a part of the battery pack 3 according to an embodiment.

FIG. 5 is a perspective view showing a front wall 31f, a baffle plate 61, a first wall portion 51 and a second wall portion 52 of a casing 31 according to an embodiment.

FIG. 6 is a view showing an example of a first wall portion 51 provided with ribs 521 according to an embodiment.

FIG. 7 is a left side view showing another example of the battery pack 3 according to an embodiment.

FIG. 8 is a left side view showing, on an enlarged scale, a part of another example of the battery pack 3 according to an embodiment.

FIG. 9 is a left side view showing, on an enlarged scale, a part of another example of the battery pack 3 according to an embodiment.

FIG. 10 is a perspective view showing the front wall 31f, a first wall portion 51a and a third wall portion 53a of the casing 31 according to an embodiment.

FIG. 11 is a view showing the first wall portion 51a according to an embodiment.

FIG. 12 is a view showing the third wall portion 53a according to an embodiment.

### DETAILED DESCRIPTION

An embodiment of the present invention will now be described with reference to the drawings. Like elements are denoted by like reference signs, and will not be described redundantly. The terms front, rear, up, down, left and right, as used in the description below, refer to these directions as seen from a passenger seated on a seat of an electric vehicle. The designations F, Re, L, R, U and D, as used in the figures, refer to front, rear, left, right, up and down, respectively. The embodiment to be described below is illustrative, and the present invention is not limited to the following embodiment.

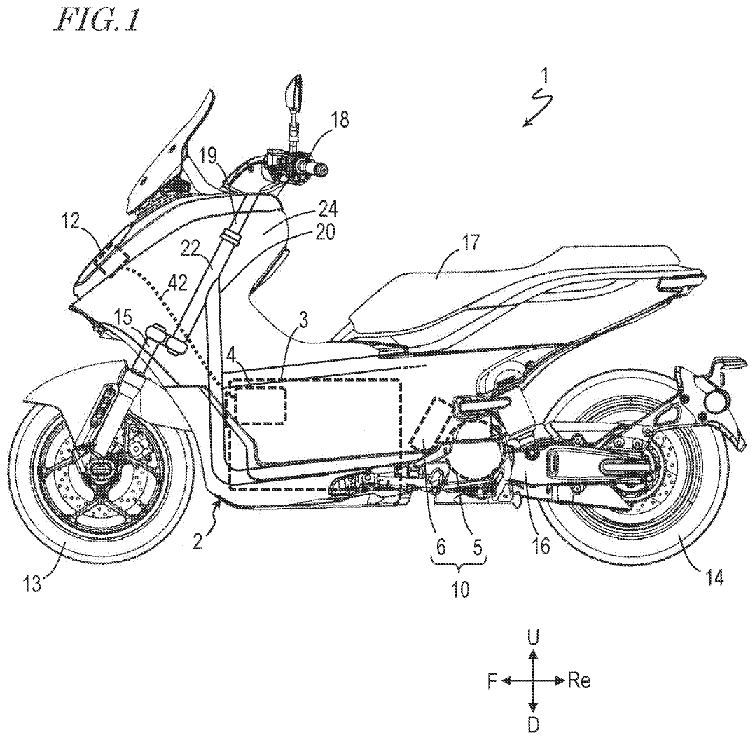

FIG. 1 is a left side view showing an electric vehicle 1, which is an example of a vehicle according to an embodiment of the present embodiment. The electric vehicle 1 is, for example, a straddled vehicle. In the example shown in FIG. 1, an electric vehicle 1 is a scooter-type electric two-wheeled vehicle. The electric vehicle 1 according to an embodiment of the present invention is not limited to a scooter-type electric two-wheeled vehicle as illustrated herein. The electric vehicle 1 according to an embodiment of the present invention may be any other type of an electric two-wheeled vehicle, including so-called on-road, off-road and moped-type electric two-wheeled vehicles. A straddled vehicle means any vehicle that is straddled by a passenger, and is not limited to a two-wheeled vehicle. A straddled vehicle may be a type of a three-wheeled vehicle (LMW) that changes its direction of travel by tilting the vehicle body, or any other type of an electric vehicle, such as an ATV (All Terrain Vehicle). The electric vehicle 1 may be an electric vehicle other than a straddled vehicle. The electric vehicle 1 may be a vehicle with four or more wheels.

As shown in FIG. 1, the electric two-wheeled vehicle 1 includes a vehicle body 2, a battery pack 3, a charger 4, a drive unit 10, a front wheel 13 and a rear wheel 14. In order to clearly illustrate the configuration of the electric two-wheeled vehicle 1, FIG. 1 shows, in a see-through manner, a part of the interior of the electric two-wheeled vehicle 1.

The vehicle body 2 has a structure including a vehicle body frame 20 and a vehicle body cover 24. The vehicle body frame 20 includes a head pipe 22. A steering shaft 19 is inserted into the head pipe 22. A front fork 15 is provided at the lower end of the steering shaft 19. The front fork 15 is capable of rotating left and right about the center of the steering shaft 19 inserted in the head pipe 22. The front wheel 13 is rotatably supported at the lower end portion of the front fork 15. A steering handle 18 is provided at the upper end of the steering shaft 19.

The rear portion of the vehicle body 2 swingably supports a swing arm 16. The rear wheel 14 is rotatably supported by the swing arm 16. In this example, the driven wheel is the rear wheel 14 and the non-driven wheel is the front wheel 13. A seat 17, on which the passenger is seated, is provided in the upper portion of the vehicle body 2.

The battery pack 3 is arranged at a position between the front wheel 13 and the rear wheel 14 in the vehicle front-rear direction of the vehicle 1. The drive unit 10 is arranged rearward of the battery pack 3. The drive unit 10 includes an electric motor 5 and a motor control unit (MCU) 6 that controls the operation of the electric motor 5. The battery pack 3 supplies electric power to operate the electric motor 5. The MCU 6 generates the drive current from the output current of the battery pack 3 and outputs the drive current to the electric motor 5. The rotation generated by the electric motor 5 is transmitted to the rear wheel 14 via a belt-driven power transmission mechanism, for example, thereby causing the electric two-wheeled vehicle 1 to travel. The rotation generated by the electric motor 5 may be transmitted to the rear wheel 14 via a chain-driven or shaft-driven power transmission mechanism.

An AC charging port 12 is provided at the front portion of the vehicle body 2. A charger 4 is arranged on the side of the battery pack 3. The AC charging port 12 includes a receptacle to or from which a connector (plug) of an external power source outputting an alternating current for charging the battery pack 3 can be attached or detached, and receives alternating current output from an external power source. The AC charging port 12 is connected to the charger 4 via a harness 42. When charging the battery pack 3, the alternating current output from the external power source is supplied to the charger 4 via the AC charging port 12. The charger 4 converts the alternating current to direct current and outputs the current to the battery pack 3. The direct current output from the charger 4 is supplied to the battery pack 3 via a harness, for example.

The vehicle body 2 may be provided with a DC charging port that receives the direct current output from the external power source. In this case, the direct current output from the external power source is supplied to the battery pack 3 via a DC charging port 11 to charge the battery pack 3.

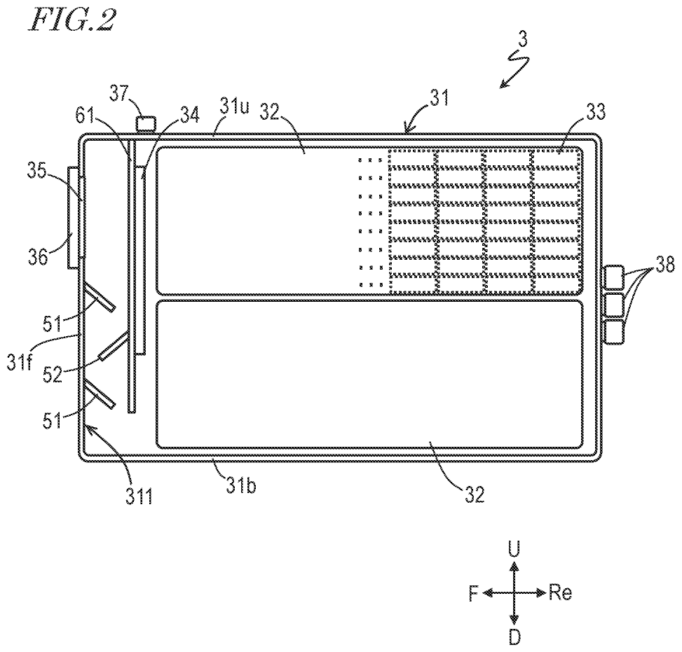

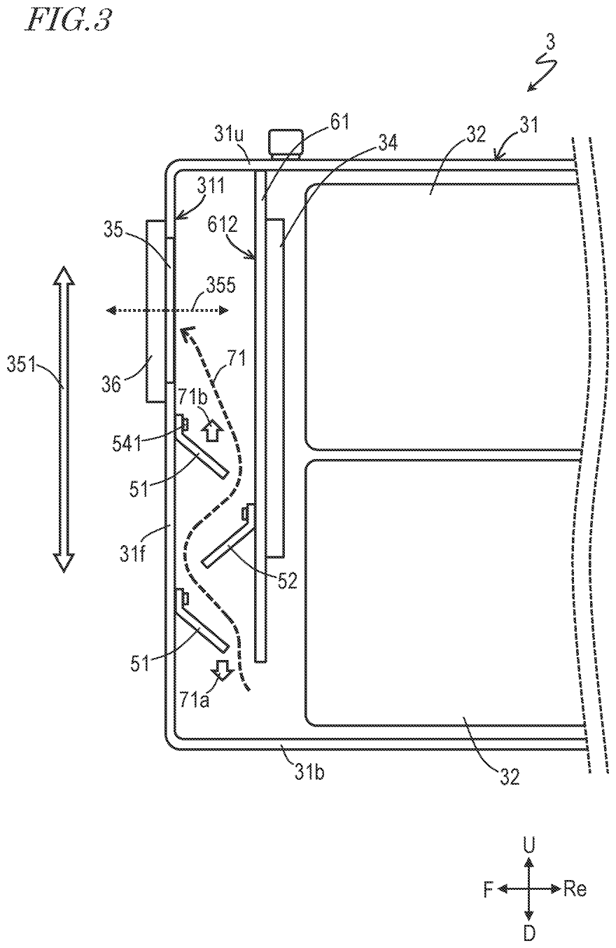

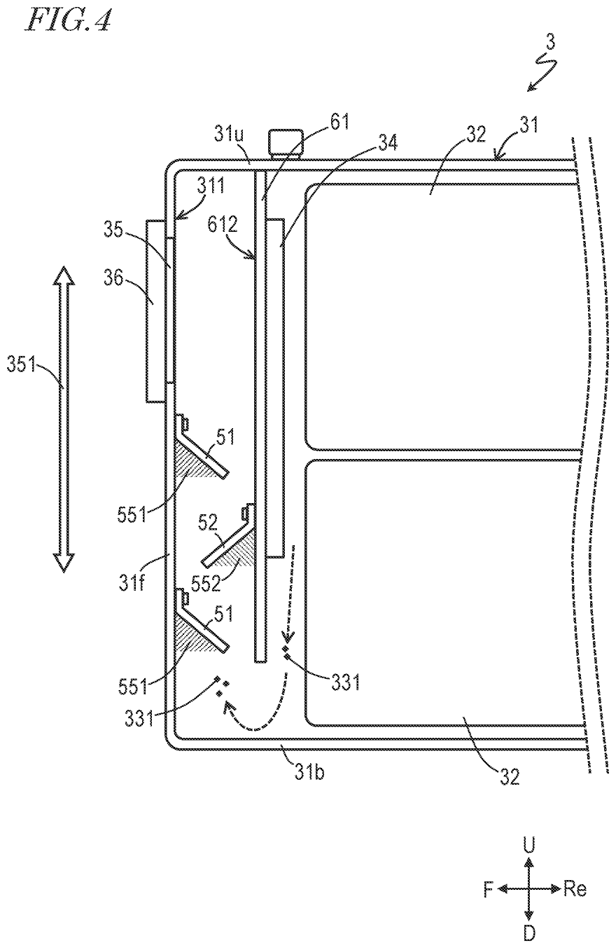

FIG. 2 is a left side view of the battery pack 3. FIG. 3 and FIG. 4 are left side views each showing, on an enlarged scale, a part of the battery pack 3. FIG. 2, FIG. 3 and FIG. 4 show the interior of the battery pack 3.

The battery pack 3 includes a casing 31, a battery module 32 and a battery management system (BMS) 34. The casing 31 houses the battery module 32 and the BMS 34. The number of battery modules 32 provided by the battery pack 3 may be any number, and one or more battery modules 32 are housed in the casing 31. Each of the battery modules 32 includes a plurality of battery cells 33. The number of battery cells 33 included by each battery module 32 may be any number.

The BMS 34 controls the operation of the battery pack 3, such as the charging operation and the discharging operation of the battery pack 3. The casing 31 is provided with connectors 37 and 38. A harness that connects together the battery pack 3 and the charger 4 is connected to the connector 37. A harness that connects together the battery pack 3 and the MCU 6 is connected to the connector 38.

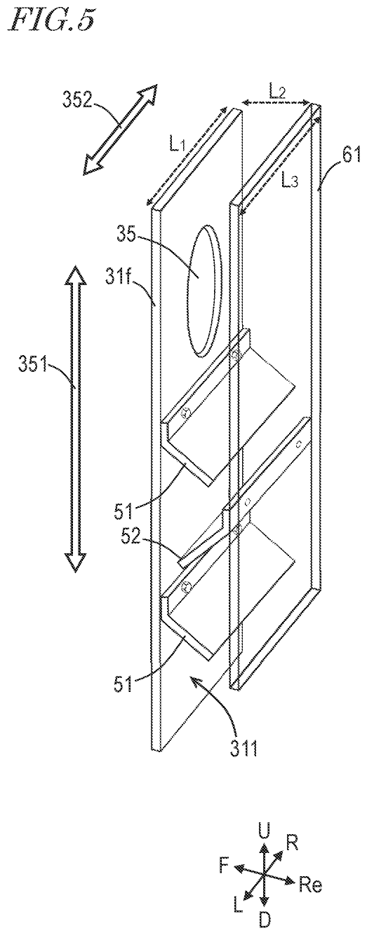

An outlet 35 through which to discharge the gas inside the casing 31 to the outside is provided on a front wall 31f of the casing 31. For the purpose of explanation of the configuration of the battery pack 3, the side of the battery pack 3 on which the outlet 35 is provided will be described in the present embodiment as the front side. For the purpose of explanation, the longitudinal direction 351 of the front wall 31f will be described as the up-down direction, and the width direction 352 (FIG. 5) perpendicular to the longitudinal direction 351 will be described as the left-right direction.

A pressure relief device (PRD) 36 is provided on the front wall 31F of the casing 31 so as to cover the outlet 35. When the pressure inside the battery cells 33 increases, gas may be discharged from the battery cells 33. The gas discharged from the battery cells 33 is discharged to the outside of the battery pack 3 through the outlet 35 and the pressure relief device 36.

A first surface 311, which is an inner surface of the front wall 31f of the casing 31, opposes the battery module 32. The battery module 32 is arranged with an interval from the first surface 311 so as to form a gas passageway between the first surface 311 and the battery module 32. The gas passageway is a channel for flowing gas discharged from the battery cells 33.

In the example shown in FIG. 2 to FIG. 4, a baffle plate (obstruction plate) 61 is arranged between the first surface 311 of the casing 31 and the battery module 32. The baffle plate 61 extends downward from an upper wall 31u of the casing 31. A gap is provided between the lower end portion of the baffle plate 61 and a bottom wall 31b of the casing 31. As shown in FIG. 3, a gas passageway (the first gas passageway) 71 for flowing the gas discharged from the battery cells 33 is formed between the first surface 311 of the casing 31 and the baffle plate 61. The gas discharged from the battery cells 33 can reach the outlet 35 through the gas passageway 71.

The battery pack 3 includes a first wall portion 51 extending from the first surface 311 of the casing 31. The battery pack 3 further includes a second wall portion 52 extending from a second surface 612 of the baffle plate 61 opposing the first surface 311.

The first wall portion 51 is fixed to the front wall 31f using a fastener 541 such as a bolt, for example. The first wall portion 51 may be formed integrally with the front wall 31f. The second wall portion 52 is fixed to the baffle plate 61 using the fastener 541 such as a bolt, for example. The second wall portion 52 may be formed integrally with the baffle plate 61.

FIG. 5 is a perspective view showing the front wall 31f, the baffle plate 61, the first wall portion 51 and the second wall portion 52 of the casing 31. In order to clearly show the shape of the first wall portion 51 and the second wall portion 52, FIG. 5 shows the baffle plate 61 in a see-through manner.

As shown in FIG. 2 to FIG. 5, the first wall portion 51 is shaped so as to extend away from the first surface 311 while extending toward the upstream side of the gas passageway 71. Here, the arrow 71a shown in FIG. 3 indicates the upstream side of the gas passageway 71, and the arrow 71b indicates the downstream side of the gas passageway 71. In plan view as seen from the width direction (the left-right direction) of the first surface 311 of the casing 31, the first wall portion 51 is shaped so as to extend in a direction diagonal to the axial direction 355 (FIG. 3) of the outlet 35 and away from the first surface 311. The first wall portion 51 is arranged so as to provide a gap between the first wall portion 51 and the baffle plate 61.

The second wall portion 52 is shaped so as to extend in a direction away from the second surface 612 of the baffle plate 61 while extending toward the upstream side of the gas passageway 71. The second wall portion 52 is arranged so as to provide a gap between the second wall portion 52 and the first surface 311. In the longitudinal direction 351 of the first surface 311 of the casing 31, the first wall portion 51 and the second wall portion 52 are arranged staggered from each other.

The first wall portion 51 and the second wall portion 52 each extend in the width direction 352 (FIG. 5). The left end portions of the first wall portion 51 and the second wall portion 52 are in contact with the left side wall of the casing 31. The right end portions of the first wall portion 51 and the second wall portion 52 are in contact with the right side wall of the casing 31. The baffle plate 61 extends in the width direction 352, and the left end portion of the baffle plate 61 is in contact with the left side wall of the casing 31 and the right end portion thereof is in contact with the right side wall of the casing 31.

As described above, when the pressure inside the battery cells 33 increases, gas may be discharged from the battery cells 33. Also, when the pressure inside the battery cells 33 increases, solid objects 331 (FIG. 4) such as particulate matter derived from the constituents of the battery cells 33 may be discharged together with the gas from the battery cells 33. As the gas generated from the battery cells 33 flows toward the outlet 35, such solid objects 331 may move together with the gas toward the outlet 35. In the present embodiment, the solid objects 331 moving toward the outlet 35 are captured by the first wall portion 51 and the second wall portion 52.

The baffle plate 61 is arranged between the first surface 311 of the casing 31 and the battery module 32. With the arrangement of the baffle plate 61, it is possible to guide the gas and the solid objects 331 generated from the battery cells 33 to a location where the first wall portion 51 and the second wall portion 52 are arranged. It is possible to prevent the moving solid objects 331 from heading directly to the outlet 35 without passing through the location where the first wall portion 51 and the second wall portion 52 are arranged to capture those solid objects 331.

Although the solid objects 331 are urged to move together with the gas along the gas passageway 71, since the solid objects 331 have a relatively large mass and are subject to relatively large inertia force, the solid objects 331 cannot easily change their direction of travel and are captured by the first wall portion 51 and the second wall portion 52.

The first wall portion 51 is shaped so as to extend away from the first surface 311 of the casing 311 while extending toward the upstream side of the gas passageway 71. With this shape, the solid objects 331 can be captured in the space 551 formed between the first surface 311 of the casing 31 and the first wall portion 51 (the hatched area in FIG. 4). The second wall portion 52 is shaped so as to extend away from the second side 612 of the baffle plate 61 while extending toward the upstream side of the gas passageway 71. The solid objects 331 can be captured in the space 552 formed between the second surface 612 of the baffle plate 61 and the second wall portion 52 (the hatched area in FIG. 4).

The first wall portion 51 and the second wall portion 52 extend in different directions and are arranged staggered from each other in the longitudinal direction 351. By meandering the gas passageway 71, it is possible to efficiently capture the solid objects 331, which have a relatively large mass and are difficult to change their direction of travel.

Many components are required to be arranged inside the casing 31 of the battery pack 3. Therefore, the interval L₂ (FIG. 5) can be small between the first surface 311 of the casing 31 opposing the battery module 32 and the battery module 32. The length L₁ of the first surface 311 of the casing 31 in the width direction 352 is larger relative to the interval L₂. With the length L₁ of the first surface 311 in the width direction 352 being large, the length of the root portion of the first wall portion 51 fixed to the first surface 311 can be made large, thereby increasing the rigidity of the first wall portion 51. For example, if the first wall portion 51 has a cantilevered structure, the length of the fixed end that is fixed to the first surface 311 can be made large, thereby increasing the rigidity of the wall surface. Therefore, even under conditions where high stress is applied to the first wall portion 51 due to the movement of the gas and the solid objects 331, it is possible to suppress distortion of the first wall portion 51 and efficiently capture the solid objects 331.

The length La of the baffle plate 61 in the width direction (the left-right direction) is also larger relative to the interval L₂. Therefore, the length of the root portion of the second wall portion 52 fixed to the second surface 612 of the baffle plate 61 can be made large, and it is possible to increase the rigidity of the second wall portion 52 as with the first wall portion 51.

In the present embodiment, with the provision of the first wall portion 51 for capturing the solid objects 331 in the casing 31 of the battery pack 3, it is possible to efficiently capture the solid objects 331 with a simple structure. Since there is no need to provide relatively large components such as an exhaust duct in the casing 31, it is possible to increase the degree of freedom in the arrangement of components in the casing 31 and reduce the size of the battery pack 3.

In the example shown in FIG. 2 to FIG. 5, two first wall portions 51 and one second wall portion 52 are provided in the casing 31, but there is no limitation on the number of those wall portions. The number of first wall portions 51 and the number of second wall portions 52 are arbitrary, and one or more first wall portions 51 and one or more second wall portions 52 may be provided.

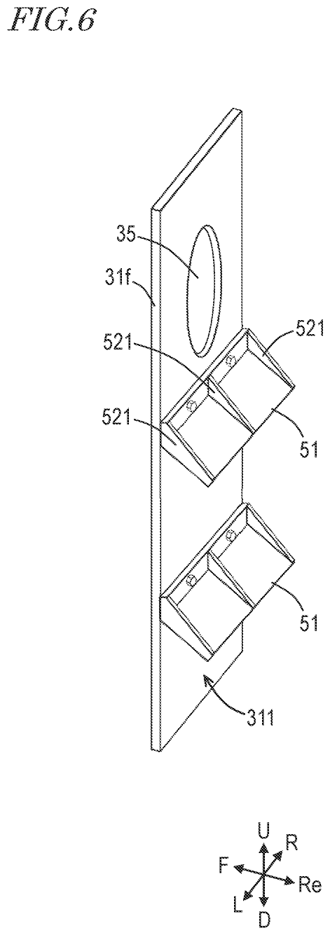

The first wall portion 51 may be provided with ribs in order to further increase the rigidity of the first wall portion 51. FIG. 6 shows an example of the first wall portion 51 provided with ribs 521. By providing the ribs 521 on the first wall portion 51, it is possible to further increase the rigidity of the first wall portion 51. The second wall portion 52 may be provided with ribs. Then, it is possible to further increase the rigidity of the second wall portion 52.

In the example shown in FIG. 2 to FIG. 5, the BMS 34 is provided on the baffle plate 61. Supporting the BMS 34 by the baffle plate 61 eliminates the need to provide an additional member to support the BMS 34, and it is possible to improve the degree of freedom in the arrangement of components in the casing 31.

Next, another example of the battery pack 3 of the present embodiment will be described.

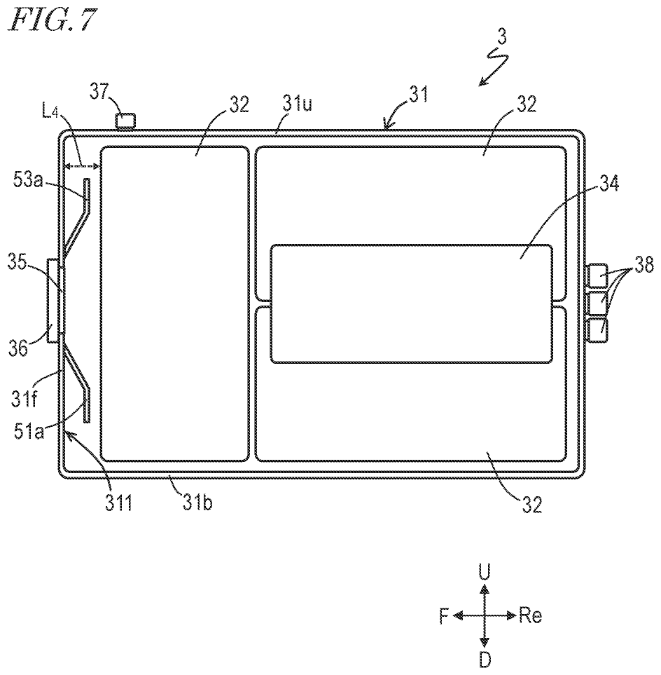

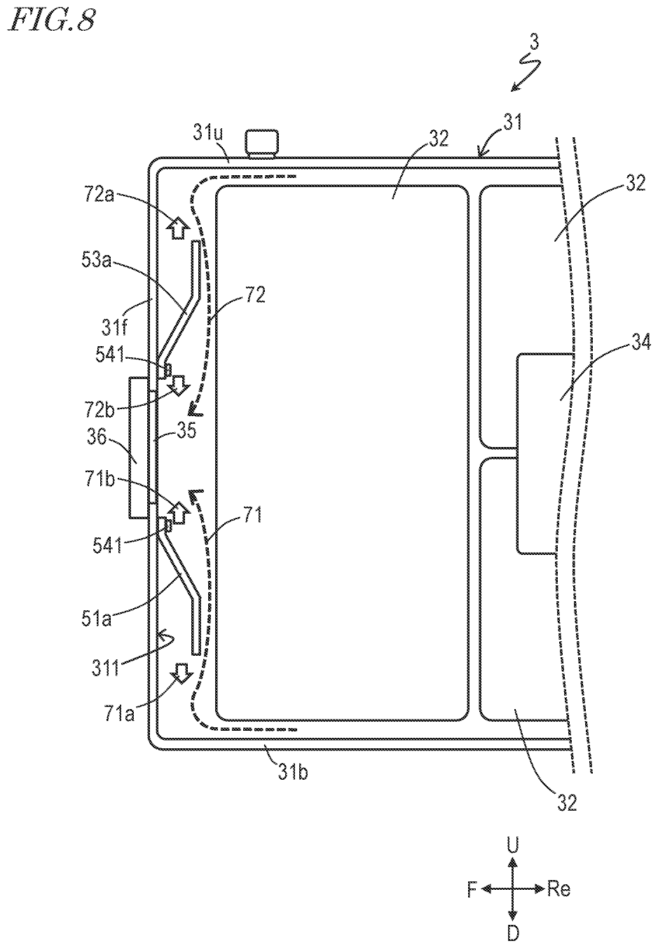

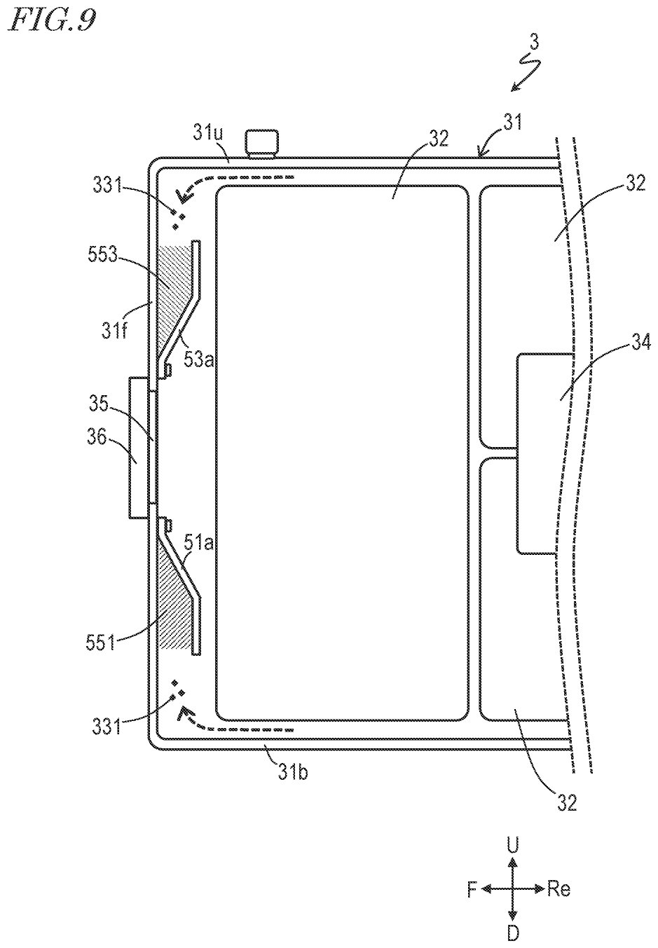

FIG. 7 is a left side view showing the battery pack 3 of another example. FIG. 8 and FIG. 9 are left side views showing, on an enlarged scale, a part of the battery pack 3 of another example. FIG. 7, FIG. 8 and FIG. 9 show the interior of the battery pack 3.

The first surface 311 of the casing 31 opposes the battery module 32. The battery module 32 is arranged with an interval from the first surface 311 so as to form gas passageways 71, 72 (FIG. 8) between the first surface 311 and the battery module 32.

The gas passageway (the second gas passageway) 72 has a different direction of gas flow than the gas passageway 71. For example, the gas passageway 71 is a passageway in which gas travels in the upward direction in the casing 31, and the gas passageway 72 is a passageway in which gas travels in the downward direction in the casing 31. The gas discharged from the battery cells 33 can reach the outlet 35 through the gas passageways 71 and 72. By providing a plurality of gas passageways to guide the gas discharged from the battery cells 33 to the outlet 35, it is possible to efficiently guide the gas to the outlet 35.

The battery pack 3 includes a first wall portion 51a and a third wall portion 53a extending from the first surface 311 of the casing 31. The first wall portion 51a and the third wall portion 53a are fixed to the front wall 31f using the fastener 541 such as a bolt, for example. The first wall portion 51a and the third wall portion 53a may be formed integrally with the front wall 31f.

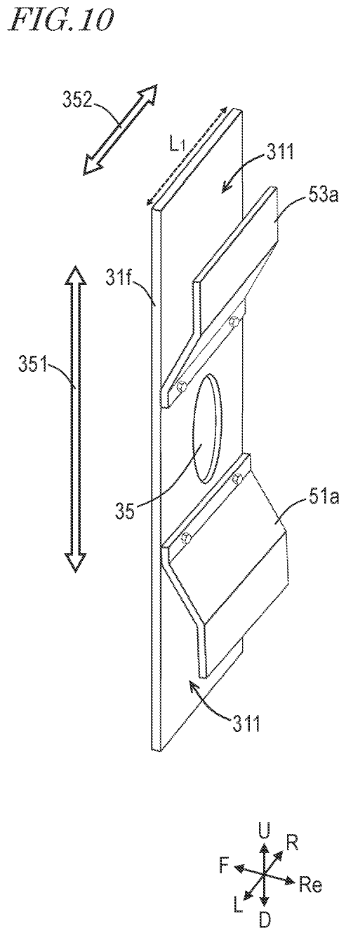

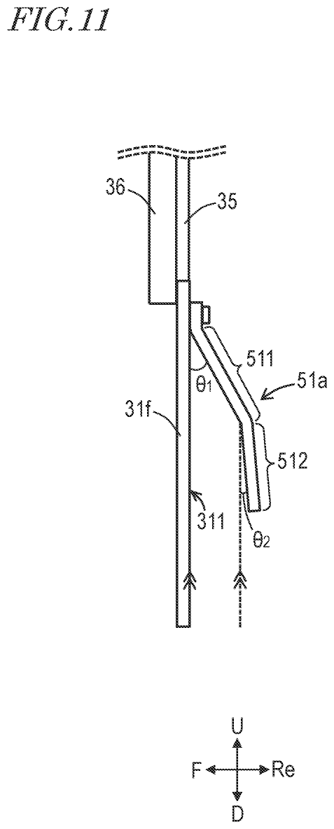

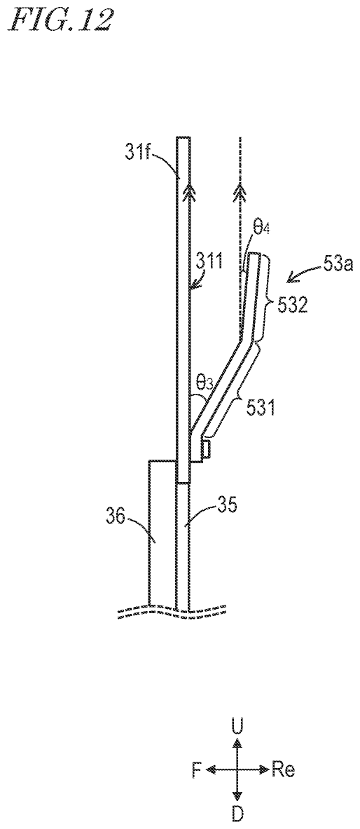

FIG. 10 is a perspective view showing the front wall 31f, the first wall portion 51a and the third wall portion 53a of the casing 31. FIG. 11 is a view showing the first wall portion 51a. FIG. 12 is a view showing the third wall portion 53a.

As shown in FIG. 7 to FIG. 12, the first wall portion 51a is shaped so as to extend away from the first surface 311 while extending toward the upstream side of the gas passageway 71. The arrow 71a shown in FIG. 8 indicates the upstream side of the gas passageway 71 and the arrow 71b indicates the downstream side of the gas passageway 71. The first wall portion 51a is arranged so as to provide a gap between the first wall portion 51a and the battery module 32.

As shown in FIG. 11, the first wall portion 51a includes a first portion 511 and a second portion 512. The first portion 511 is shaped such that one end thereof extends from the first surface 311 of the casing 31 and so as to extend away from the first surface 311 while extending toward the upstream side of the gas passageway 71. The second portion 512 is shaped so as to extend from the other end of the first portion 511 in a direction toward the upstream side of the gas passageway 71. The inclination of the second portion 512 relative to the first surface 311 is smaller than the inclination of the first portion 511 relative to the first surface 311. In other words, the angle θ₂ formed by the first surface 311 and the second portion 512 is smaller than the angle θ₁ formed by the first surface 311 and the first portion 511 in plan view as seen from the width direction of the first surface 311 (the left-right direction). The direction in which the second portion 512 extends may be parallel to the first surface 311. With the first wall portion 51a having the first portion 511 and the second portion 512, it is possible to increase the space 551 (FIG. 9) to capture the solid objects 331.

As shown in FIG. 7 to FIG. 12, the third wall portion 53a is shaped so as to extend away from the first surface 311 while extending toward the upstream side of the gas passageway 72. The arrow 72a shown in FIG. 8 indicates the upstream side of the gas passageway 72 and the arrow 72b indicates the downstream side of the gas passageway 72. The third wall portion 53a is arranged so as to provide a gap between the third wall portion 53a and the battery module 32.

As shown in FIG. 12, the third wall portion 53a includes a first portion 531 and a second portion 532. The first portion 531 is shaped such that one end thereof extends from the first surface 311 of the casing 31 and so as to extend away from the first surface 311 while extending toward the upstream side of the gas passageway 72. The second portion 532 is shaped so as to extend from the other end of the first portion 531 in a direction toward the upstream side of the gas passageway 72. The inclination of the second portion 532 relative to the first surface 311 is smaller than the inclination of the first portion 531 relative to the first surface 311. In other words, the angle θ₄ formed by the first surface 311 and the second portion 532 is smaller than the angle θ₃ formed by the first surface 311 and the first portion 531 in plan view as seen from the width direction of the first surface 311 (the left-right direction). The direction in which the second portion 532 extends may be parallel to the first surface 311. With the third wall portion 53a having the first portion 531 and the second portion 532, it is possible to increase the space 553 (FIG. 9) to capture the solid objects 331.

The first wall portion 51a and the third wall portion 53a each extend in the width direction 352 (FIG. 10). The left end portions of the first wall portion 51a and the third wall portion 53a are in contact with the left side wall of the casing 31. The right end portions of the first wall portion 51a and the third wall portion 53a are in contact with the right side wall of the casing 31.

In this example, when the solid objects 331 (FIG. 9) are discharged from the battery cells 33, the solid objects 331 moving toward the outlet 35 are captured by the first wall portion 51a and the third wall portion 53a. Although the solid objects 331 are urged to move together with the gas along the gas passageways 71 and 72, since the solid objects 331 have a relatively large mass and are subject to relatively large inertia force, the solid objects 331 cannot easily change their direction of travel and move generally along the first surface 311, and are captured by the first wall portion 51a and the third wall portion 53a.

Since many components are required to be arranged inside the casing 31 of the battery pack 3, the interval L₄ (FIG. 7) can be small between the first surface 311 of the casing 31 and the battery module 32. The length L₁ (FIG. 10) of the first surface 311 of the casing 311 in the width direction 352 is relatively larger than the interval L₄. With the length L₁ of the first surface 311 in the width direction 352 being large, the length of the root portions of the first wall portion 51a and the third wall portion 53a fixed to the first surface 311 can be made large, thereby increasing the rigidity of the first wall portion 51a and the third wall portion 53a.

With the provision of the first wall portion 51a and the third wall portion 53a in the casing 31 of the battery pack 3 for capturing the solid objects 331, it is possible to efficiently capture the solid objects 331 with a simple structure. Since there is no need to provide relatively large components such as an exhaust duct in the casing 31, it is possible to increase the degree of freedom in the arrangement of components in the casing 31 and reduce the size of the battery pack 3.

In the example shown in FIG. 7 to FIG. 10, one first wall portion 51a and one third wall portion 53a are provided in the casing 31, but there is no limitation on the number of those wall portions. The number of first wall portions 51a and the number of third wall portions 53a are arbitrary, and one or more first wall portions 51a and one or more third wall portions 53a may be provided. The first wall portion 51a and the third wall portion 53a may be provided with ribs in order to further increase the rigidity of the first wall portion 51a and the third wall portion 53a.

The shape of the first wall portion 51a and the third wall portion 53a may be the shape of the first wall portion 51 shown in FIG. 2 to FIG. 5. The shape of the first wall portion 51 and the second wall portion 52 may be a shape that includes the first portion 511 and the second portion 512 (FIG. 11) as with the first wall portion 51a.

Although the battery pack 3 is arranged in the electric vehicle 1 so that the longitudinal direction 351 of the front wall 31f of the casing 31 is the up-down direction of the electric vehicle 1 in the embodiment described above, the arrangement of the battery pack 3 is not limited to this. For example, the battery pack 3 may be arranged in the electric vehicle 1 so that the longitudinal direction 351 of the front wall 31f is the left-right direction of the electric vehicle 1. In this case, the walls 31u and 31b of the casing 31 are side walls of the casing 31.

Although the vehicle 1 on which the battery pack 3 is mounted is a vehicle in the embodiment described above, it is not limited to a vehicle in the present invention, but may be a ship, an aircraft, a robot, etc., driven by an electric motor. The present invention is also applicable to hybrid systems that use both an electric motor and an internal combustion engine. The vehicle 1 is not limited to transportation machines in which people ride, but may be transportation machines that operate unmanned. The present invention can be applied to machines that operate using battery packs.

Illustrative embodiments of the present invention have been described above. The present specification discloses a battery pack and a vehicle as set forth in the following items.

### [Item 1]

A battery pack 3 including:
a battery module 32;
a casing 31 that houses the battery module 32, wherein:
the battery module 32 is arranged with an interval from a first surface 311 of the casing 31 opposing the battery module 32 so as to form a first gas passageway 71 between the battery module 32 and the first surface 311 of the casing 31;
an outlet 35 through which to discharge gas inside the casing 31 to outside is located on the first surface 311 of the casing 31; and
the battery pack 3 further includes a first wall portion 51 extending from the first surface 311 of the casing 31 where the outlet 35 is located, the first wall portion 51 being shaped so as to extend in a direction away from the first surface 311 while extending toward an upstream side of the first gas passageway 71.

The battery pack 3 according to an embodiment of the present invention includes the first wall portion 51 that extends from the first surface 311 of the casing 31 where the outlet 35 is located. The first wall portion 51 is shaped so as to extend in a direction away from the first surface 311 of the casing 31 while extending toward the upstream side of the first gas passageway 71. When solid objects 331 derived from the constituents of the battery cells 33 occur, it is possible to capture those solid objects 331 by the first wall portion 51.

Many components are required to be arranged inside the casing 31 of the battery pack 3. Therefore, the interval L₂ can be small between the first surface 311 of the casing 31 opposing the battery module 32 and the battery module 32. The length L₁ of the first surface 311 of the casing 31 in the width direction is larger relative to the interval L₂. With the length L₁ of the first surface 311 of the casing 31 in the width direction being large, the length of the root portion of the wall portion 51 fixed to the first surface 311 can be made large, thereby increasing the rigidity of the wall portion 51. For example, if the wall portion 51 has a cantilevered structure, the length of the fixed end that is fixed to the first surface 311 of the casing 31 can be made large, thereby increasing the rigidity of the wall surface. Therefore, even under conditions where high stress is applied to the wall portion 51 due to the movement of the gas and the solid objects 331, it is possible to suppress distortion of the wall portion 51 and efficiently capture the solid objects 331.

With the provision of the wall portion 51 for capturing the solid objects 331 in the casing 31 of the battery pack 3, it is possible to efficiently capture the solid objects 331 with a simple structure. Since there is no need to provide relatively large components such as an exhaust duct in the casing 31, it is possible to increase the degree of freedom in the arrangement of components in the casing 31 and reduce the size of the battery pack 3.

### [Item 2]

The battery pack 3 according to item 1, wherein:
in plan view as seen from a width direction of the first surface 311 of the casing 31,
the first wall portion 51 is shaped so as to extend in a direction diagonal to an axial direction 355 of the outlet 35 and away from the first surface 311.

Thus, solid objects 331 that move through the first gas passageway 71 can be captured by the first wall portion 51.

### [Item 3]

The battery pack 3 according to item 1 or 2, wherein the first wall portion 51 includes:
a first portion 511 shaped such that one end thereof extends from the first surface 311 of the casing 31 and so as to extend away from the first surface 311 while extending toward the upstream side of the first gas passageway 71; and
a second portion 512 that extends from the other end of the first portion 511 in a direction toward the upstream side of the first gas passageway 71, with inclination of the second portion 512 relative to the first surface 311 being smaller than inclination of the first portion 511 relative to the first surface 311.

Thus, it is possible to increase the space 551 to capture the solid objects 331.

### [Item 4]

The battery pack 3 according to any one of items 1 to 3, further including:
a baffle plate 61 arranged between the battery module 32 and the first surface 311 of the casing 31, wherein:
the first gas passageway 71 is formed between the baffle plate 61 and the first surface 311 of the casing 31; and
the first wall portion 51 is arranged so as to provide a gap between the first wall portion 51 and the baffle plate 61.

Thus, it is possible to prevent the solid objects 331 discharged from the battery module 32 from heading directly to the outlet 35 without passing through the location where the first wall portion 51 is arranged to capture those solid objects 331. It is possible to guide those solid objects 331 to a location where the first wall portion 51 is arranged.

### [Item 5]

The battery pack 3 according to item 4, further including a second wall portion 52 that extends from a second surface 612 of the baffle plate 61 opposing the first surface 311 of the casing 31, wherein the second wall portion 52 is shaped so as to extend away from the second surface 612 while extending toward the upstream side of the first gas passageway 71 and is provided so as to provide a gap between the second wall portion 52 and the first surface 311 of the casing 31.

As the solid objects 331 are captured by means of both the first wall portion 51 and the second wall portion 52, which extend in different directions, it is possible to more efficiently capture the solid objects 331.

### [Item 6]

The battery pack 3 according to item 5, wherein the first wall portion 51 and the second wall portion 52 are arranged staggered from each other in a longitudinal direction 351 of the first surface 311 of the casing 31.

Thus, it is possible to efficiently capture the solid objects 331, which have a relatively large mass and are difficult to change their direction of travel.

### [Item 7]

The battery pack 3 according to any one of items 4 to 6, wherein:
a control device 34 that controls an operation of the battery pack 3,
wherein the control device 34 is provided on the baffle plate 61.

Thus, the control device 34 can be supported by the baffle plate 61. [Item 8]

The battery pack 3 according to any one of items 1 to 3, wherein:
a second gas passageway 72, separate from the first gas passageway 71, is further formed between the first surface 311 of the casing 31 and the battery module 32, wherein the second gas passageway 72 has a different direction of gas flow than the first gas passageway 71; and
the battery pack 3 further includes a third wall portion 53 that extends from the first surface 311 of the casing 31 where the outlet 35 is located, the third wall portion 53 being shaped so as to extend in a direction away from the first surface 311 while extending toward the upstream side of the second gas passageway 72.

By providing a plurality of gas passageways 71 and 72 to guide the gas inside the casing 31 to the outlet 35, it is possible to efficiently guide the gas in the casing 31 to the outlet 35.

By arranging wall portions 51 and 53 in the first gas passageway 71 and the second gas passageway 72, respectively, it is possible to efficiently capture the solid objects 331.

### [Item 9]

The battery pack 3 according to any one of items 1 to 8, further including a pressure relief device 36 provided on the casing 31 so as to cover the outlet 35.

As the wall portions capture the solid objects 331, it is possible to reduce the amount of the solid objects 331 that deposit in the pressure relief device 36.

### [Item 10]

A vehicle 1 including the battery pack 3 according to any one of items 1 to 9.

Thus, when solid objects 331 derived from the constituents of the battery cells 33 occur in the battery pack 3 mounted on the vehicle 1, it is possible to capture those solid objects 331 in the casing 31.

The present invention is particularly useful in the field of machines that operate using battery packs.

What is claimed is:

1. A battery pack comprising:
a battery module;
a casing that houses the battery module, the casing having:
a wall, of which an inner surface is a first surface, the battery module being arranged opposing the first surface with an interval therebetween, so as to form a first gas passageway between the battery module and the first surface, and
an outlet formed in the wall, gas inside the casing being dischargeable, sequentially through the first gas passageway and the outlet, to an outside of the casing; and
a first wall portion extending from the first surface of the casing, the first wall portion being shaped so as to extend away from the first surface while extending toward an upstream side of the first gas passageway.

2. The battery pack according to claim 1, wherein:
the first surface is substantially rectangular defining a longitudinal direction and a width direction, and
in a view as seen from the width direction, the first wall portion is shaped so as to extend in a direction diagonal to an axial direction of the outlet and away from the first surface.

3. The battery pack according to claim 1, wherein the first wall portion includes:
a first portion shaped to extend from the first surface of the casing, the first portion extending away from the first surface while extending toward the upstream side of the first gas passageway; and
a second portion that further extends from the first portion toward the upstream side of the first gas passageway, with an inclination of the second portion relative to the first surface being smaller than an inclination of the first portion relative to the first surface.

4. The battery pack according to claim 1, further comprising:
a baffle plate arranged between the battery module and the first surface of the casing, wherein
the first gas passageway includes a passageway formed between the baffle plate and the first surface of the casing; and
the first wall portion and the baffle plate have a gap therebetween.

5. The battery pack according to claim 4, further comprising a second wall portion that extends from a second surface, which is a surface of the baffle plate opposing the first surface of the casing, wherein
the second wall portion is shaped so as to extend away from the second surface while extending toward the upstream side of the first gas passageway, and
the second wall portion and the first surface of the casing have another gap therebetween.

6. The battery pack according to claim 5, wherein
the first surface is substantially rectangular defining a longitudinal direction and a width direction, and
the first wall portion and the second wall portion are arranged staggered from each other in the longitudinal direction.

7. The battery pack according to claim 4, further comprising:
a control device that controls an operation of the battery pack, wherein
the control device is provided on the baffle plate.

8. The battery pack according to claim 1, wherein:
a second gas passageway is further formed between the first surface of the casing and the battery module, the second gas passageway being so shaped that the gas inside the casing is further dischargeable, sequentially through the second gas passageway, in a flow direction different from that of the gas in the first gas passageway, and the outlet, to the outside of the casing; and
the battery pack further includes a third wall portion that extends from the first surface of the casing, the third wall portion being shaped so as to extend away from the first surface while extending toward an upstream side of the second gas passageway.

9. The battery pack according to claim 1, further comprising a pressure relief device provided on the casing so as to cover the outlet.

10. A vehicle comprising the battery pack according to claim 1.
